(19) United States
(12) Patent Application Publication
(10) Pub. No.: US 2014/0290361 A1
(43) Pub. Date: Oct. 2, 2014

(54) APPARATUS FOR DRIVING GYROSCOPE SENSOR

(71) Applicant: SAMSUNG ELECTRO-MECHANICS CO., LTD., Suwon-si (KR)

(72) Inventors: Sung Tae KIM, Suwon-si (KR); Young Kil CHOI, Suwon-si (KR); Jun Kyung NA, Suwon-si (KR); Seung Chul PYO, Suwon-si (KR); Chang Hyun KIM, Suwon-si (KR)

(73) Assignee: SAMSUNG ELECTRO-MECHANICS CO., LTD., Suwon-si (KR)

(21) Appl. No.: 14/140,375

(22) Filed: Dec. 24, 2013

(30) Foreign Application Priority Data
Dec. 28, 2012 (KR) 10-2012-0157180

(51) Int. Cl. G01C 19/5776

(52) U.S. Cl. CPC G01C 19/5776
USPC 73/504.12

(57) ABSTRACT

Disclosed herein is an apparatus for driving a gyroscope sensor, including: multi-axis sensing means; detecting circuit means; switching means that is disposed between the axes of the multi-axis sensing means and the detecting circuit means so as to connect or disconnect between the axes of the multi-axis sensing means and the detecting circuit means according to a switching control signal; and control means that controls the switching means such that the axes of the multi-axis sensing means and the detecting circuit means are sequentially connected or disconnected. By providing Integrated detecting circuit means to detect gyro signals on axes from a gyroscope sensor, size can be reduced and power consumption (current) and cost can be saved.

### CROSS REFERENCE TO RELATED APPLICATION

This application claims the benefit of Korean Patent Application No. 10-2012-0157180, filed on Dec. 28, 2012, entitled “Apparatus for Driving Gyroscope Snesor,” which is hereby incorporated by reference in its entirety into this application.

### BACKGROUND OF THE INVENTION

1. Technical Field

The present invention relates to an apparatus for driving a gyroscope sensor.

2. Description of the Related Art

Gyroscope sensors are used for detecting an angular velocity and are being used in various applications, for example, military applications such as an artificial satellite, a missile, an unmanned aircraft, vehicle applications such as an air bag, electronic stability control (ESC), a black box for a vehicle, hand shaking prevention of a camcorder, motion sensing of a mobile phone or a game console, navigation, or the like.

Typically, a gyroscope sensor detects a signal using the Coriolis Effect based on resonance of a gyroscope sensor element, and uses a demodulator and a high-order filter to separate a resonant signal from a gyro signal.

Generally, in processing signals by resonance in a gyroscope sensor, due to time delay in filters, demodulators and high-order filters having the same configuration are used for all of the axes in a multi-axis (e.g., three-axis) gyroscope sensor.

This increases not only size of the gyroscope sensor but also power consumption, as well as cost for configuring circuits for all of the axes.

Such a gyroscope sensor having the same configurations in all of the axes is disclosed in, for example, Patent Document 1 which relates to a vibrating gyroscope.

### RELATED ART DOCUMENT

### Patent Document

(Patent Document 1) Korea Patent No. 10-1157709

### SUMMARY OF THE INVENTION

The present invention has been made in an effort to provide an apparatus for driving a gyroscope sensor which provides integrated detecting circuit means to detect gyro signals on axes from a gyroscope sensor and uses switching means to allow signals to sequentially pass on the axes in a time division scheme, to detect the gyro signals on the axes.

According to a first preferred embodiment of the present invention, there is provided an apparatus for driving a gyroscope sensor, including: multi-axis sensing means that senses output signals generated by vibrations of a driving mass and the Coriolis force for axes upon applying driving signals to the axes of the gyroscope sensor; detecting circuit means that detects gyro signals for the axes from the output signals output from the multi-axis sensing means; switching means that is disposed between the axes of the multi-axis sensing means and the detecting circuit means so as to connect or disconnect between the axes of the multi-axis sensing means and the detecting circuit means according to a switching control signal; and control means that controls the switching means such that the axes of the multi-axis sensing means and the detecting circuit means are sequentially connected or disconnected.

The multi-axis sensing means may include: an x-axis sensing unit that receives a sensing signal on an x-axis generated by a corresponding one of the driving signals applied to the axes of the gyroscope sensor to sense an x-axis output signal; a y-axis sensing unit that receives a sensing signal on a y-axis generated by a corresponding one of the driving signals applied to the axes of the gyroscope sensor to sense a y-axis output signal; and a z-axis sensing unit that receives a sensing signal on a z-axis generated by a corresponding one of the driving signals applied to the axes of the gyroscope sensor to sense a z-axis output signal.

The detecting circuit means may include: a charge amp that converts changes in charges of the output signals on the axes sensed by the multi-axis sensing means into voltage signals to output the converted signals; a band pass filter that removes noise from the voltage signals output from the charge amp; a sample-and-hold (S/H) circuit that samples-and-holds the voltage signals for the axes filtered by the band pass filter according to a S/H clock signal in synchronization with a signal by resonance on the axes so as to detect gyro signals; an analog-to-digital converter (ADC) that converts the gyro signals detected by the S/H circuit into digital signals to output the converted signals; and a driving module that receives the output signals output from the multi-axis sensing means to generate the S/H clock signal to be provided to the S/H circuit and generates driving signals to be applied to driving electrodes of the gyroscope sensor.

The band pass filter may include: a high pass filter that filters 1/f noise (flicker noise); and a low pass filter that filters noise by aliasing of the S/H circuit.

The driving module may include: a clock generator unit that receives the output signals for the axes from the multi-axis sensing means to generate a first S/H clock signal in synchronization with a corresponding one of the output signals and outputs the first S/H clock signal to the S/H circuit; an inverter that inverts the first S/H clock signal output from the clock generating unit to generate a second S/H clock signal and outputs the second S/H clock signal to the S/H circuit; a phase shift circuit that shifts the phases of the output signals output from the multi-axis sensing means to generate driving signals for the axes; an inverting circuit that inverts the driving signals output from the phase shift circuit to generate inverted signals each corresponding to the respective axes; and a driving circuit that applies the driving signals for the axes and the inverted signals to driving electrodes of the gyroscope sensor.

The phase shift circuit may include: a first phase shift unit that shifts a phase of an output signal output from the first sensing unit to generate a driving signal for the x-axis; a second phase shift unit that shifts a phase of an output signal output from the second sensing unit to generate a driving signal for the y-axis; and a third phase shift unit that shifts a phase of an output signal output from the third sensing unit to generate a driving signal for the z-axis.

The inverting circuit may include: a first inverting unit that inverts a driving signal output from the first phase shifting unit to generate an inverted voltage corresponding to the x-axis; a second inverting unit that inverts a driving signal output from the second phase shifting unit to generate an inverted voltage corresponding to the y-axis; and a third inverting unit that inverts a driving signal output from the third phase shifting unit to generate an inverted voltage corresponding to the z-axis.

The switching means may include: a first switching unit that switches between the x-axis sensing unit of the multi-axis sensing means and the detecting circuit means according to a first switching control signal; a second switching unit that switches between the y-axis sensing unit of the multi-axis sensing means and the detecting circuit means according to a second switching control signal; and a third switching unit that switches between the z-axis sensing unit of the multi-axis sensing means and the detecting circuit means according to a third switching control signal.

The control means may sequentially apply the first to third switching control signals to the switching means so as to sequentially connect or disconnect between the sensing units of the multi-axis sensing means and the detecting circuit means.

The detecting circuit means may include: a programmable gain amplifier (PGA) that amplifies gains of voltage signals output from the S/H circuit to output the amplified voltage signal; and a low pass filter that filters the amplified voltage signals from the PGA to output the filtered signals.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for driving a gyroscope sensor according to a first preferred embodiment of the present invention;

FIGS. 2A to 2E are graphs of voltage signals VCM at individual elements in a case that there is no gyro signal;

FIGS. 3A to 3E are graphs of output signals at individual elements in a case that there is a gyro signal; and

FIG. 4 is a block diagram of an apparatus for driving a gyroscope sensor according to second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

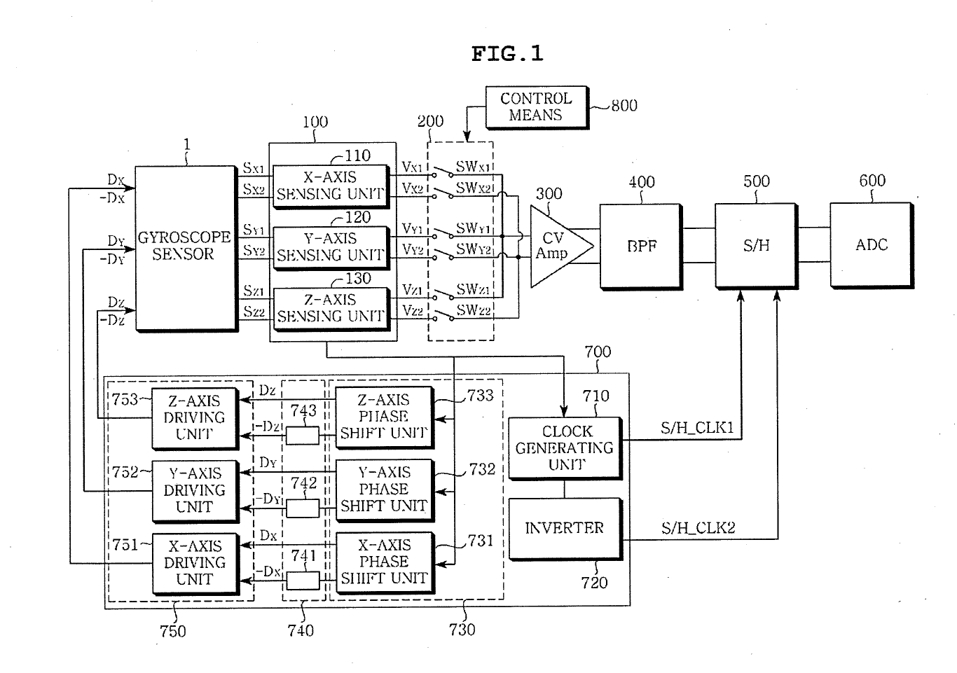

FIG. 1 is a block diagram of an apparatus for driving a gyroscope sensor according to a first preferred embodiment of the present invention.

Referring to FIG. 1, the apparatus for driving a gyroscope sensor according to the first preferred embodiment of the present invention includes multi-axis sensing means 100; detecting circuit means detecting a gyro signal from an output signal for each of axes from the multi-axis sensing means 100; switching means 200 disposed between the multi-axis sensing means 100 and the detecting circuit means; and control means 800.

The multi-axis sensing means 100 receives sensing signals S_{X1}, S_{X2}, S_{Y1}, S_{Y2}, S_{Z1}, and S_{Z2} from axes generated by vibration of driving masses in the axes caused by driving signals D_{X}, −D_{X}, D_{Y}, −D_{Y}, D_{Z}, and −D_{Z} applied to the gyroscope sensor 1 and the Coriolis force, and senses output signals V_{S}=V_{X1}, V_{X2}, V_{Y1}, V_{Y2}, V_{Z1}, and V_{Z2} in which sensor resonant signals and gyro signals are combined. The output signal Vs may be expressed by Equation 1.

Vₛ=A sin(2πf_{R}t)+B cos(2πf_{Ω}t)×cos(2πf_{R}t) [Equation 1]

Where A sin(2πf_{R}t) denotes a sensor resonant signal, B cos(2πf_{Ω}t)×cos(2πf_{R}t) denotes a gyro signal, f_{R} denotes a sensor resonant frequency, f_{Ω} denotes a gyro frequency, and t denotes time.

The multi-axis sensing means 100 may include, for example, three-axis sensor having an x-axis sensing unit 110, a y-axis sensing unit 120, and a z-axis sensing unit 130 as shown in FIG. 1 and may receive driving signals D_{X}, −D_{X}, D_{Y}, −D_{Y}, D_{Z}, and −D_{Z} for the axes from a driving module 700 to be described below.

The detecting circuit means detects a gyro signal of each of the axes from the output signals from the multi-axis sensing means 100 and may include a charge amp 300, a band pass filter (BPF) 400, a sample-and-hold (S/H) circuit 500, an analog-digital converter (ADC) 600 and a driving module 700.

The charge amp 300 converts changes in charges of output signals of the axes sensed by the multi-axis sensing means 100 (for example, charges between sensing electrodes sensed through a sensing electrode (not shown) of one of the axes) into a voltage signal VCM to output it.

The band pass filter (BFP) 400 removes noise from the voltage signal VCM output from the charge amp 300. The band pass filter (BPF) 400 may include, for example, a high pass filter HPF to reduce 1/f noise (flicker noise), and a low pass filter LPF to suppress noise generated by aliasing of the S/H circuit 500.

In the band pass filter (BPF) 400, the center of the pass band is the resonant frequency band, and no switched capacitor filter is required since the resonant frequency is approximately several tens of KHz or higher.

Further, since the band pass filter (BPF) 400 has a fast group delay time, the time taken from when an output signal sensed by the multi-axis sensing means 100 is input until it is output is also fast.

Therefore, detecting units 110, 120 and 130 of the multi-axis sensing means 100 may sequentially implement signal passes for axes by switching of the switching means 200 to thereby detect a gyro signal.

The S/H circuit 500 samples-and-holds the voltage signal VCM output from the band pass filter (BPF) 400 according to a S/H clock signal in synchronization with a signal by resonance of one of the axes of the multi-axis sensing means 100, to output it.

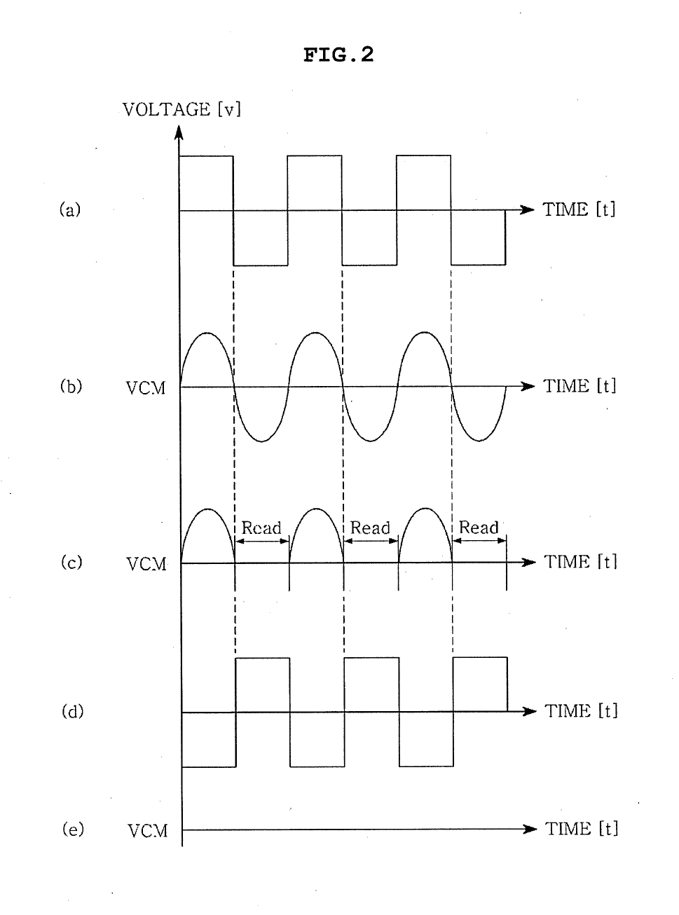

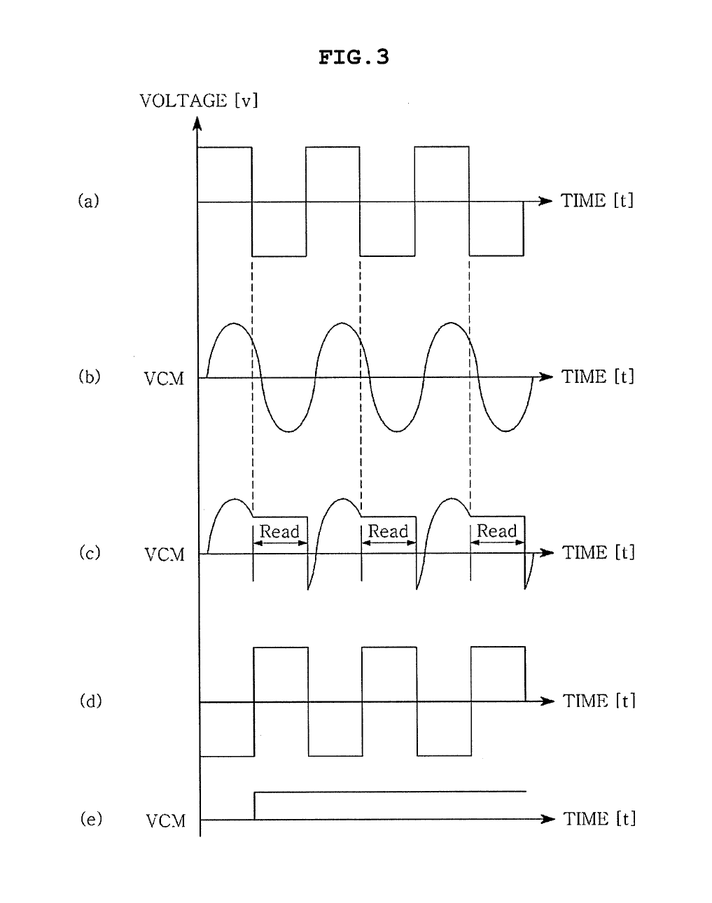

The operation of the S/H circuit 500 will be described in detail with reference to FIGS. 2A to 2E and FIGS. 3A to 3E.

FIGS. 2A to 2E are graphs of voltage signals VCM at individual elements in a case that there is no gyro signal, whereas FIGS. 3A to 3E are graphs of output signals at individual elements in a case that there is a gyro signal.

Referring to FIGS. 2A to 2E, FIG. 2A represents a first S/H clock signal S/H_CLK1 provided to the S/H circuit 500. When the S/H clock signal is at a positive edge according to the first S/H clock signal S/H_CLK1, a voltage signal VCM output from the charge amp 300 is sampled, whereas when the S/H clock signal is at a negative, a voltage signal VCM output from the charge amp 300 is held (the first sample-and-hold is performed).

Then, after the first S/H clock signal S/H_CLK1 is inverted by an inverter 720, according to the inverted S/H clock signal (referred hereinafter to as a second S/H clock signal S/H_CLK2), when the second S/H clock signal S/H_CLK2 is at a positive edge, the voltage signal VCM which has been subjected to the first sample-and-hold is sampled, whereas when the second S/H clock signal S/H_CLK2 is at a negative edge, the voltage signal VCM which has been subjected to the first sample-and-hold is held (the second sample-and-hold is performed).

If the sample-and-hold is performed at a negative edge of the second S/H clock signal S/H_CLK2, a signal by the sensor resonance becomes 0, and no gyro signal exists, either, so that the final output result becomes 0.

Likewise, referring to FIGS. 3A to 3E, FIG. 3A represents a first S/H clock signal S/H_CLK1 provided to the S/H circuit 500. When the S/H clock signal is at a positive edge according to the first S/H clock signal S/H_CLK1, a voltage signal VCM output from the charge amp 300 is sampled, whereas when the S/H clock signal is at a negative, a voltage signal VCM output from the charge amp 300 is held (the first sample-and-hold is performed).

Then, after the first S/H clock signal S/H_CLK1 is inverted by the inverter 720, according to the inverted S/H clock signal (referred hereinafter to as a second S/H clock signal S/H_CLK2), when the second S/H clock signal S/H_CLK2 is at a positive edge, the voltage signal VCM which has been subjected to the first sample-and-hold is sampled, whereas when the second S/H clock signal S/H_CLK2 is at a negative edge, the voltage signal VCM which has been subjected to the first sample-and-hold is held (the second sample-and-hold is performed).

If the sample-and-hold is performed at a negative edge of the second S/H clock signal S/H_CLK2, a signal by the sensor resonance becomes 0, and a phase difference between the signal by the sensor resonance and a gyro signal is 90°, so that the gyro signal becomes the maximum value.

Accordingly, by performing the first and second sample-and-holds using the first S/H clock signal (S/H_CLK1) in synchronization with the resonance frequency of the gyroscope sensor, it is possible to selectively extract a desired gyro signal from the voltage signal VCM.

The second S/H clock signal used in the second sample-and-hold is a non-overlapping clock signal generated by inverting the S/H clock signal in the first sample-and-hold using the inverter 720. As a result, a read time is reduced and a more accurate gyro signal may be obtained.

The ADC 600 converts the gyro signal detected by the S/H circuit 500 into a digital signal so as to output it to a device in which the gyroscope sensor 1 is employed.

The driving module 700 generates driving signals D_{X}, −D_{X}, D_{Y}, −D_{Y}, D_{Z}, and −D_{Z} for the axes of the gyroscope sensor 1 to apply them to driving electrodes (not shown) of the gyroscope sensor 1.

The driving module 700 includes a clock generating unit 710, the inverter 720, a phase shift circuit 730, an inverting circuit 740, and a driving circuit 750.

The clock generating unit 710 receives output signal V_{S}=V_{X1}, V_{X2}, V_{Y1}, V_{Y2}, V_{Z1}, and V_{Z2} for the axes from the multi-axis sensing means 100 and generates the first S/H clock signal S/H_CLK1 in synchronization with the output signal V_{S}=V_{X1}, V_{X2}, V_{Y1}, V_{Y2}, V_{Z1}, and V_{Z2} to output them to the S/H circuit 500.

The inverter 720 inverts the first S/H clock signal S/H_CLK1 to generate the second S/H clock signal S/H CLK2 and outputs it to the S/H circuit 500.

The phase shift circuit 730 shifts phases of the output signals V_{S}=V_{X1}, V_{X2}, V_{Y1}, V_{Y2}, V_{Z1}, and V_{Z2} output from the multi-axis sensing means 100 to generate driving signals for the axes D_{X}, D_{Y}, and D_{Z}, and includes an x-axis phase shifting unit 731, a y-axis phase shifting unit 732, and a z-axis phase shifting unit 733.

The inverting circuit 740 inverts the driving signals D_{X}, D_{Y}, and D_{Z} output from the phase shift circuit 730 to generate inverted signals −D_{X}, −D_{Y}, and −D_{Z} for the axes, and includes an x-axis inverting unit 741, a y-axis inverting unit 742, and a z-axis inverting unit 743.

The driving circuit 750 applies the driving signals D_{X}, D_{Y}, and D_{Z} and inverted signals −D_{X}, −D_{Y}, and −D_{Z} for the axes to the driving electrodes of the gyroscope sensor 1.

The switching means 200 is installed between the axes of the multi-axis sensing means 100 and the detecting circuit means to connect or disconnect between them according to a control signal.

The switching means 200 may include a first switching unit SW_{X1} and SW_{X2} to switch between the x-axis sensing unit 110 of the multi-axis sensing means 100 and the detecting circuit means according to a first switching control signal, a second switching unit SW_{Y1} and SW_{Y2} to switch between the y-axis sensing unit 120 of the multi-axis sensing means 100 and the detecting circuit means according to a second switching control signal, and a third switching unit SW_{Z1} and SW_{Z2} to switch between the z-axis sensing unit 130 of the multi-axis sensing means 100 and the detecting circuit means according to a third switching control signal.

The control means 800 is responsible for general control over the apparatus for driving a gyroscope sensor according to the first preferred embodiment of the present invention, and, especially, controls switching of the switching means 200 such that the axes of the multi-axis sensing means 100 and the detecting circuit means are connected or disconnected sequentially (in a time division scheme, for example).

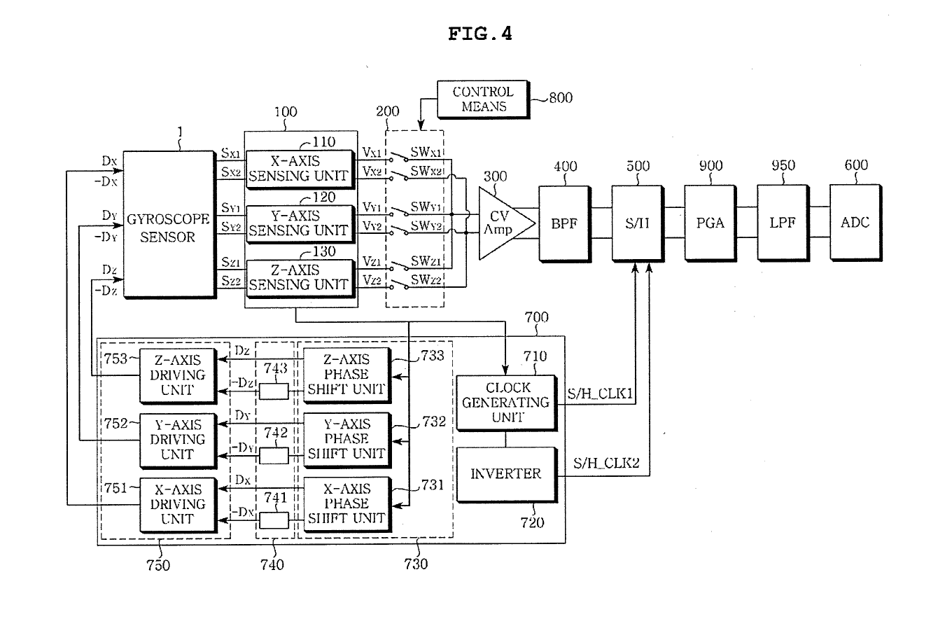

FIG. 4 is a block diagram of an apparatus for driving a gyroscope sensor according to a second preferred embodiment of the present invention. The apparatus for driving a gyroscope sensor according to the second preferred embodiment of the present invention has the same structure with that according to the first preferred embodiment shown in FIG. 1 except for a programmable gain amplifier (PGA) 900 and a low pass filter LPF 950. Therefore, descriptions on the same elements will not be made.

Referring to FIG. 4, the PGA 900 and the LPF 950 may be further employed if signals are saturated by the resonance of the gyroscope sensor prior to performing sample-and-hold in the S/H circuit 500 so that the gain is insufficient or if it is necessary to adjust the gain depending on applications.

The PGA 900 amplifies the gain of the voltage signal VCM output from the S/H circuit 500 to output it. The LPF 950 filters the voltage signal VCM amplified by the PGA 900 to output it.

As set forth above, according to the present invention, by providing integrated detecting circuit means to detect gyros signals on axes from a gyroscope sensor, size can be reduced and power consumption (current) and cost can be saved.

Although the embodiments of the present invention have been disclosed for illustrative purposes, it will be appreciated that the present invention is not limited thereto, and those to skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for driving a gyroscope sensor, comprising:
multi-axis sensing means that senses output signals generated by vibrations of a driving mass and the Coriolis force for axes upon applying driving signals to the axes of the gyroscope sensor;
detecting circuit means that detects gyro signals for the axes from the output signals output from the multi-axis sensing means;
switching means that is disposed between the axes of the multi-axis sensing means and the detecting circuit means so as to connect or disconnect between the axes of the multi-axis sensing means and the detecting circuit means according to a switching control signal; and
control means that controls the switching means such that the axes of the multi-axis sensing means and the detecting circuit means are sequentially connected or disconnected.

2. The apparatus as set forth in claim 1, wherein the multi-axis sensing means includes:
an x-axis sensing unit that receives a sensing signal on an x-axis generated by a corresponding one of the driving signals applied to the axes of the gyroscope sensor to sense an x-axis output signal;
a y-axis sensing unit that receives a sensing signal on a y-axis generated by a corresponding one of the driving signals applied to the axes of the gyroscope sensor to sense a y-axis output signal; and
a z-axis sensing unit that receives a sensing signal on a z-axis generated by a corresponding one of the driving signals applied to the axes of the gyroscope sensor to sense a z-axis output signal.

3. The apparatus as set forth in claim 2, wherein the detecting circuit means includes:
a charge amp that converts changes in charges of the output signals on the axes sensed by the multi-axis sensing means into voltage signals to output the converted signals;
a band pass filter that removes noise from the voltage signals output from the charge amp;
a sample-and-hold (S/H) circuit that samples-and-holds the voltage signals for the axes filtered by the band pass filter according to a S/H clock signal in synchronization with a signal by resonance on the axes so as to detect gyro signals;
an analog-to-digital converter (ADC) that converts the gyro signals detected by the S/H circuit into digital signals to output the converted signals; and
a driving module that receives the output signals output from the multi-axis sensing means to generate the S/H clock signal to be provided to the S/H circuit and generates driving signals to be applied to driving electrodes of the gyroscope sensor.

4. The apparatus as set forth in claim 3, wherein the band pass filter includes: a high pass filter that filters 1/f noise (flicker noise); and a low pass filter that filters noise by aliasing of the S/H circuit.

5. The apparatus as set forth in claim 3, wherein the driving module includes:
a clock generator unit that receives the output signals for the axes from the multi-axis sensing means to generate a first S/H clock signal in synchronization with a corresponding one of the output signals and outputs the first S/H clock signal to the S/H circuit;
an inverter that inverts the first S/H clock signal output from the clock generating unit to generate a second S/H clock signal and outputs the second S/H clock signal to the S/H circuit;
a phase shift circuit that shifts the phases of the output signals output from the multi-axis sensing means to generate driving signals for the axes;
an inverting circuit that inverts the driving signals output from the phase shift circuit to generate inverted signals each corresponding to the respective axes; and
a driving circuit that applies the driving signals for the axes and the inverted signals to driving electrodes of the gyroscope sensor.

6. The apparatus as set forth in claim 5, wherein the phase shift circuit includes:
a first phase shifting unit that shifts a phase of an output signal output from the first sensing unit to generate a driving signal for the x-axis;
a second phase shifting unit that shifts a phase of an output signal output from the second sensing unit to generate a driving signal for the y-axis; and
a third phase shifting unit that shifts a phase of an output signal output from the third sensing unit to generate a driving signal for the z-axis.

7. The apparatus as set forth in claim 6, wherein the inverting circuit includes:
a first inverting unit that inverts a driving signal output from the first phase shifting unit to generate an inverted voltage corresponding to the x-axis;
a second inverting unit that inverts a driving signal output from the second phase shifting unit to generate an inverted voltage corresponding to the y-axis; and
a third inverting unit that inverts a driving signal output from the third phase shifting unit to generate an inverted voltage corresponding to the z-axis.

8. The apparatus as set forth in claim 7, wherein the switching means includes:
a first switching unit that switches between the x-axis sensing unit of the multi-axis sensing means and the detecting circuit means according to a first switching control signal;
a second switching unit that switches between the y-axis sensing unit of the multi-axis sensing means and the detecting circuit means according to a second switching control signal; and
a third switching unit that switches between the z-axis sensing unit of the multi-axis sensing means and the detecting circuit means according to a third switching control signal.

9. The apparatus as set forth in claim 8, wherein the control means sequentially applies the first to third switching control signals to the switching means so as to sequentially connect or disconnect between the sensing units of the multi-axis sensing means and the detecting circuit means.

10. The apparatus as set forth in claim 3, wherein the detecting circuit means includes:
a programmable gain amplifier (PGA) that amplifies gains of voltage signals output from the S/H circuit to output the amplified voltage signal; and
a low pass filter that filters the amplified voltage signals from the PGA to output the filtered signals.
